(19) United States
(12) Patent Application Publication
(10) Pub. No.: US 2026/0279381 A1
(43) Pub. Date: Sep. 17, 2026

(54) AUDIO DATA PROCESSING METHOD, NEURAL NETWORK TRAINING METHOD, AND RELATED APPARATUS

(71) Applicant: TENCENT TECHNOLOGY (SHENZHEN) COMPANY LIMITED, Shenzhen (CN)

(72) Inventors: Xiaozhong JI, Shenzhen (CN); Junwei ZHU, Shenzhen (CN); Chuming LIN, Shenzhen (CN)

(73) Assignee: TENCENT TECHNOLOGY (SHENZHEN) COMPANY LIMITED, Shenzhen (CN)

(21) Appl. No.: 19/667,910

(22) Filed: May 5, 2026

Related U.S. Application Data
(63) Continuation of application No. PCT/CN2025/078027, filed on Feb. 19, 2025.

(30) Foreign Application Priority Data
Feb. 29, 2024 (CN) 202410232157.0

(51) Int. Cl. G10L 25/30; G06V 40/16

(52) U.S. Cl. CPC G10L 25/30; G06V 40/174

(57) ABSTRACT

An audio data processing method includes: determining facial prior information of a virtual object based on reference video data; determining a target audio feature based on target audio data; determining target expression sequence information based on the facial prior information and the target audio feature; and determining target video data corresponding to the target audio data based on the target expression sequence information and a reference frame in the reference video data.

### CROSS-REFERENCE TO RELATED APPLICATIONS

This application is a bypass continuation application of International Patent Application No. PCT/CN2025/078027, filed on Feb. 19, 2025, which claims priority to and is based on Chinese Patent Application No. 202410232157.0, entitled “AUDIO DATA PROCESSING METHOD AND APPARATUS” filed on Feb. 29, 2024, the disclosures of which are incorporated herein in their entireties by reference.

### FIELD

The present disclosure relates to the field of artificial intelligence services, and more specifically, to processing audio data.

### BACKGROUND

Audio-driven face generation technologies may include parsing information such as emotion and intonation based on inputted audio signals, and controlling expressions and actions of virtual characters in real time based on the information, thereby achieving highly synchronized performance. The technologies can be applied in various fields. For example, those can be applied in the entertainment industry, game development, the human-computer interaction interface, and the virtual reality conference. Deep learning and neural network technologies may improve expressiveness and vividness.

However, audio-driven face generation technologies may face a series of technical challenges. An example challenge includes difficulties in accurately synchronizing audio data and mouth movements. Consequently, it may be difficult for a generated facial animation to perfectly match speech content. Also, in terms of processing complex facial micro details and texture, it may be difficult to achieve an ideal realistic visual image effect, resulting in less realistic virtual faces. In addition, ensuring different virtual objects display expression features consistent with their unique personalities to truly reflect individual differences can be improved. Moreover, operation efficiency and overall stability of a system for real-time applications can also be improved.

### SUMMARY

Some embodiments of the present disclosure provide an audio data processing method, a neural network training method, an audio data processing apparatus, an electronic device, and a computer-readable storage medium.

According to some embodiments of the present disclosure, an audio data processing method performed by a computer device includes determining facial prior information of a virtual object based on reference video data; determining a target audio feature based on target audio data; determining target expression sequence information based on the facial prior information and the target audio feature; and determining target video data corresponding to the target audio data based on the target expression sequence information and a reference frame in the reference video data.

According to some embodiments of the present disclosure, an audio data processing apparatus includes at least one memory configured to store computer program code; and at least one processor configured to read the program code and operate as instructed by the program code. The program code including first preprocessing code configured to cause the at least one processor to determine facial prior information of a virtual object based on reference video data; second preprocessing code configured to cause the at least one processor to determine a target audio feature based on target audio data; audio-to-expression transformer code configured to cause the at least one processor to determine target expression sequence information based on the facial prior information and the target audio feature; and expression-to-face renderer code configured to cause the at least one processor to determine target video data corresponding to the target audio data based on the target expression sequence information and a reference frame in the reference video data.

According to some embodiments of the present disclosure, a non-transitory computer-readable storage medium, storing computer program code, when executed by at least one processor, causes the at least one processor to at least, determine facial prior information of a virtual object based on reference video data; determine a target audio feature based on target audio data; determine target expression sequence information based on the facial prior information and the target audio feature; and determine target video data corresponding to the target audio data based on the target expression sequence information and a reference frame in the reference video data.

According to some embodiments of the present disclosure, the facial prior information of the virtual object in the reference video data is determined, so that a facial characteristic of the virtual object can be accurately identified, thereby determining, based on the facial prior information and the target audio feature, the target expression sequence information that conforms to the facial characteristic of the virtual object and naturally integrates the facial characteristic. When the target video data is determined based on the target expression sequence information and the reference frame, synchronization precision between audio content in the target video data and a facial component (for example, a mouth) action of the virtual object on a screen can be significantly improved, and a sense of reality of a mouth action is enhanced. In addition, an identity characteristic of the virtual object can be accurately reflected, and an expression difference between individuals is captured and reproduced more accurately. Moreover, overall operation efficiency and stability are ensured while system performance is improved. This is especially applicable to real-time video generation.

### BRIEF DESCRIPTION OF THE DRAWINGS

The above and other aspects, features, and advantages of one or more embodiments of the present disclosure will be more apparent from the following description taken in conjunction with the accompanying drawings.

FIG. 1 is an exemplary schematic diagram of a scenario according to some embodiments of the present disclosure.

FIG. 2 is a schematic diagram according to some embodiments of the present disclosure.

FIG. 3 is a flowchart of an audio data processing method according to some embodiments of the present disclosure.

FIG. 4A is a schematic diagram of an improved neural network model according to some embodiments of the present disclosure.

FIG. 4B is a schematic diagram of an audio-to-expression transformation stage according to some embodiments of the present disclosure.

FIG. 4C is a schematic diagram of an audio-to-expression transformer according to some embodiments of the present disclosure.

FIG. 4D is a schematic diagram of an expression-to-face renderer according to some embodiments of the present disclosure.

FIG. 5A is a flowchart of a neural network training method according to some embodiments of the present disclosure.

FIG. 5B is a schematic diagram of training an audio-to-expression transformer according to some embodiments of the present disclosure.

FIG. 6 is a comparison diagram of experimental results according to some embodiments of the present disclosure.

FIG. 7 is a schematic diagram of an electronic device according to some embodiments of the present disclosure.

FIG. 8 is a schematic architectural diagram of an exemplary computing device according to some embodiments of the present disclosure.

FIG. 9 is a schematic diagram of a storage medium according to some embodiments of the present disclosure.

### DETAILED DESCRIPTION

To make the objectives, technical solutions, and advantages of the present disclosure clearer, exemplary embodiments according to the present disclosure are described in detail below with reference to the accompanying drawings. Apparently, the described embodiments are merely some but not all of the embodiments of the present disclosure. The present disclosure is not limited by the exemplary embodiments described herein.

In the present disclosure and the accompanying drawings, basically same or similar operations and elements are represented by same or similar reference numerals, and repeated descriptions of these operations and elements are omitted. In addition, in the descriptions of the present disclosure, the terms such as “first” and “second” are only used to distinguish the description, and cannot be understood as indicating or implying relative importance or order.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

An expression, “a and/or b” may be understood as including only a, only b and both a and b. Expressions “at least one of a, b, and c” and “at least one of a, b, or c” may be understood as including only a, only b, only c, both a and b

Further, unless stated otherwise or otherwise clear from context, phrase “based on” may refer to “based at least in part on” and not “based solely on.”, both a and c, both b and c, or all of a, b, and c.

Terms such as “some embodiments” describes subsets of all possible embodiments, but “some embodiments” may be the same subset or different subsets of all the possible embodiments and may be combined with each other without conflict.

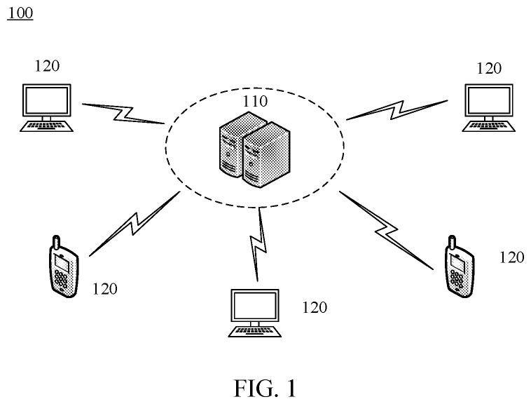

One or more components illustrated in FIGS. 1-9 may be integrated into a single component, or conversely, a single component may be implemented as multiple discrete elements. Additionally or alternatively, different subsets of the illustrated components may be combined in various configurations.

The operations, techniques, and processes described herein may be implemented via executable instructions or computer program code stored on computer-readable medium. Such computer program code may include distinct portions or modules, where each portion comprises a subset of the total instructions necessary to perform specific operations.

All models that can be used in the embodiments of the present disclosure may be artificial intelligence models, e.g., an artificial intelligence-based neural network model. Usually, the artificial intelligence-based neural network model is implemented as an acyclic graph, where neurons are arranged in different layers. Usually, the neural network model includes an input layer and an output layer, and the input layer and the output layer are separated by at least one hidden layer. The hidden layer transforms an input received by the input layer into a representation useful for generating an output in the output layer. A node is fully connected to a node in an adjacent layer via an edge, and there is no edge between nodes in each layer. Data received at a node in the input layer of a neural network is propagated to a node in the output layer through any one of the hidden layer, an activation layer, a pooling layer, a convolutional layer, or the like. The input and output of the neural network model may use various forms, which is not limited in the present disclosure.

First, an audio data processing method and an application scenario such as a corresponding apparatus according to some embodiments of the present disclosure are described with reference to FIG. 1. FIG. 1 is a schematic diagram of an application scenario 100 according to some embodiments of the present disclosure. A server 110 and a plurality of terminals 120 are schematically shown.

A neural network model in some embodiments of the present disclosure may be specifically integrated in various electronic devices, for example, any electronic device of the server 110 and the plurality of terminals 120 in FIG. 1. For example, the neural network model may be integrated in a terminal 120. The terminal 120 may be a mobile phone, a tablet computer, a notebook computer, a desktop computer, a personal computer (PC), a smart speaker, a smartwatch, or the like, but is not limited thereto. For another example, the neural network model may alternatively be integrated in the server 110. The server 110 may be an independent physical server, or may be a server cluster or a distributed system including a plurality of physical servers, or may be a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform. The terminal may be directly or indirectly connected to the server in a wired or a wireless communication manner. This is not limited in the present disclosure.

A computer device applying the neural network model in some embodiments of the present disclosure to perform reasoning may be a terminal device, a server, or a system including a terminal device and a server. The audio data processing method according to some embodiments of the present disclosure may be performed on the terminal, or may be performed on the server, or may be performed by the terminal device and the server together.

The terminal 120 and the server 110 according to some embodiments of the present disclosure both comply with a data protection principle, respect data rights of a user, and ensure data security and privacy of the user. The terminal 120 and the server 110 according to some embodiments of the present disclosure explicitly inform the user of a purpose, a method, and a scope of collecting, using, storing, transmitting, and deleting user data, and obtain consent of the user. The terminal 120 and the server 110 according to some embodiments of the present disclosure adopt proper technical and management measures to prevent the user data from being leaked, tampered, damaged, or lost. A provider of the terminal 120 and the server 110 according to some embodiments of the present disclosure regularly reviews and updates the user data, to delete expired or useless data in time. In addition or alternatively, a provider using the cloud service according to some embodiments of the present disclosure respects rights of the user such as data access, correction, deletion, consent withdrawal, complaints, and claims, and provides a convenient channel and program, so that the user can effectively exercise these rights.

Further, a process of using an artificial intelligence technology to perform data analysis in the terminal 120 or the server 110 is performed based on legal, proper, and transparent principles. Data collected and processed by an artificial intelligence model according to some embodiments of the present disclosure is relevant, necessary, and appropriate for a prediction purpose, and does not include any personal identity information or sensitive information. The neural network model according to some embodiments of the present disclosure adopts appropriate technical and organization measures to protect security and integrity of data, preventing unauthorized access, use, or leakage of data.

An artificial intelligence-based neural network model according to some embodiments of the present disclosure complies with related data protection regulations and ethical principles. The neural network model is trained based on a large amount of anonymized and de-identified data, and does not violate privacy rights of any individual or group. The artificial intelligence model is also strictly tested and evaluated, to ensure that an outputted result of the artificial intelligence model is accurate and reliable, and does not cause any misleading or discriminatory result. The artificial intelligence model is designed only for improving service quality and customer satisfaction, and is not used for any illegal or unscrupulous purpose. In addition or alternatively, the neural network model is regularly reviewed and updated to adapt to changes of a data environment and legal norms.

Traditionally, an audio-driven face generation method may be mainly classified into two types: a person-specific method and a person-generic method. A neural network model used in the person-specific method needs to be trained or fine-tuned for a specific individual before prediction, while the person-generic method can directly generate a facial speaking video of a previously unseen virtual character.

To resolve a problem of audio-to-video synchronization in the foregoing two methods, in some solutions, a mouth synchronization discriminator or a lip reading network is introduced to enhance intelligibility of a mouth region. However, such a solution still cannot resolve the problem of audio-to-video synchronization. To improve video image quality, some solutions attempt to improve image fidelity by using a diffusion model or a generative adversarial model. However, it is difficult to balance efficiency, visual quality, and mouth action precision in such a solution.

In addition or alternatively, when establishing a correspondence between audio data and a facial expression, some solutions adopt a fusion modeling method, to capture a mouth action feature more efficiently and precisely. For example, the solutions can predict a region label of a target face based on the audio data or extract key point information in an unsupervised environment. Although a facial region label and a key point are easy to obtain, these solutions cannot fully express complex facial actions such as lip pursing and closing due to inherent sparsity of the information.

Some embodiments of the present disclosure improve an architecture of a neural network model. Compared with a neural network model of a single module structure that is applicable to audio-driven face generation, an improved neural network model includes two modules that may be decoupled: an audio-to-expression transformer and an expression-to-face renderer.

Therefore, the improved neural network model can separately process inputted data at three stages to achieve higher performance. The three stages are respectively a preprocessing stage, an audio-to-expression transformation stage, and an expression-to-video frame reconstruction stage.

For example, first, at the preprocessing stage, necessary feature extraction may be performed on reference video data and target audio data by using a preprocessing module, to obtain facial prior information of a virtual object and a target audio feature. Next, at the audio-to-expression transformation stage, the audio-to-expression transformer maps the received facial prior information and the target audio feature to corresponding target expression sequence information, especially for a subtle expression change of a mouth action. Finally, at the expression-to-video frame reconstruction stage, the expression-to-face renderer precisely generates, based on the target expression sequence information, a reference frame in the reference video data, and a reference head pose feature vector corresponding to the reference frame, target video data corresponding to the target audio data. The target video data is precisely synchronized with the target audio data and has highly realistic mouth movements and facial expression details.

Compared with a single-stage solution of the neural network model that directly inputs the audio data and video data to generate an updated video image, the improved multi-stage neural network model according to some embodiments of the present disclosure can significantly improves synchronization precision between audio content and a facial component (for example, a mouth) action of the virtual object on a screen, enhances a sense of reality of the mouth action, more accurately captures and reproduces an expression difference between individuals, and ensures overall operation efficiency and stability while improving system performance.

For the improved neural network model, some embodiments of the present disclosure provides an audio data processing method, to perform reasoning by using the improved neural network model. The method includes: determining the facial prior information of the virtual object based on the reference video data; determining the target audio feature based on the target audio data; determining the target expression sequence information based on the facial prior information and the target audio feature; and determining the target video data corresponding to the target audio data based on the target expression sequence information, the reference frame in the reference video data, and the reference head pose feature vector corresponding to the reference frame.

In a process of performing reasoning by using the improved neural network, an operation of first determining a target expression sequence information and then predicting a video frame based on the target expression sequence significantly improves synchronization between the audio content and the facial component action of the virtual object on the screen. This method not only enhances the sense of reality of a facial action, but also can accurately reflect an identity characteristic of the virtual object. The method ensures operation efficiency and stability of a neural network while improving performance, which is applicable to real-time video generation.

Similarly, for the improved neural network model, some embodiments of the present disclosure further provides a neural network training method, to train the improved neural network model. The neural network includes the audio-to-expression transformer and the expression-to-face renderer, and the method includes: training the audio-to-expression transformer based on sample video data and sample audio data corresponding to the sample video data; training the expression-to-face renderer based on sample facial prior information, a sample reference frame, and a sample source video frame. The audio-to-expression transformer and the expression-to-face renderer may be separately and independently trained, and training processes of the two do not interfere with each other.

In a training process of the improved neural network model, an improved first loss function and an improved second loss function may be introduced. The two loss functions respectively optimize different aspects of characteristics. By adjusting a neural network parameter, performance of a trained neural network is improved. The first loss function and the second loss function may enable the neural network to learn and adapt to a feature of the inputted data more effectively, and optimize the neural network in a plurality aspects in the training process. This loss function design in which different characteristics are comprehensively considered helps improve a generalization capability and training efficiency of the neural network, thereby improving performance of the neural network in an actual application.

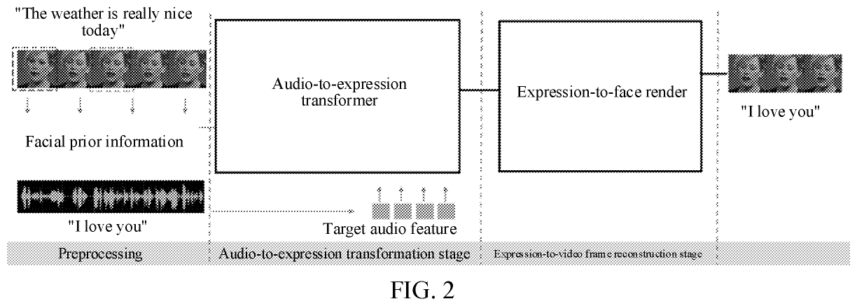

The following describes an audio data processing method, and a neural network training method and apparatus according to embodiments of the present disclosure with reference to FIG. 2 to FIG. 9.

FIG. 2 is a schematic diagram according to some embodiments of the present disclosure.

As shown in FIG. 2, a specific application scenario for implementing an audio-driven face generation technology is as following: there is a piece of video material (also referred to as reference video data below), and the video material corresponds to a piece of audio. Video content displays a facial expression, e.g., details of a mouth movement, of a virtual object when the virtual object speaks to a camera. In this video material, the virtual object says a sentence, for example, “The weather is really nice today”. To produce more videos of the virtual object more quickly, the virtual object in this video needs to be lip-synced to another piece of different audio content (also referred to as target audio data below), for example, “I love you”. In some examples, by using a technical means, for the virtual person originally saying “The weather is really nice today”, target video data is generated based on another piece of audio data. In the target video data, a lip action of the virtual object can accurately match a form and rhythm expected when the virtual object says “I love you”.

As shown in FIG. 2, a neural network model according to some embodiments of the present disclosure mainly includes two parts: an audio-to-expression transformer and an expression-to-face renderer.

In a preprocessing process, in some embodiments of the present disclosure, facial prior information is extracted from the reference video data, including but not limited to: reference facial shape information, reference expression information, and reference head pose information. In addition or alternatively, in a processing process, an audio feature is further extracted from the target audio data. In some embodiments, a 3D morphable face model (3DMM) may be used as a three-dimensional morphological model, to extract more accurate facial shape information, pose information, and expression information (for example, facial prior information such as reference facial shape information, reference expression information, and reference head pose information that are mentioned subsequently) from the reference video data, to implement accurate mapping from the video to an expression sequence. Compared with a method in which key points need to be marked in a facial region, the three-dimensional morphological model according to some embodiments of the present disclosure helps a neural network more effectively and accurately learn actions and changes of a facial component (for example, a mouth).

At an audio-to-expression transformation stage, the facial prior information extracted in preprocessing is inputted to the audio-to-expression transformer, to generate target expression sequence information, to better retain and reflect an identity characteristic and a subtle change in emotional expression of a virtual human.

At an expression-to-video frame reconstruction stage, the target expression sequence information is used as an input of the expression-to-face renderer, so that the renderer can accurately generate a movement video picture of a target facial component (for example, a component such as a mouth, eyes, ears, and eyebrows of a target face) by using an improved facial identity alignment module. In some embodiments, the expression-to-face renderer may use a face-based individual alignment module (FIA), which can obtain a target video frame conforming to a facial personality feature of the virtual person during pronunciation by using only a reference video frame. Compared with a method, the expression-to-face renderer according to some embodiments of the present disclosure improves personalized expression of the target video frame, reduces computational costs, and helps improve a reasoning speed.

In some embodiments of the present disclosure, fine details of the facial component (which is configured for characterizing a virtual organ) can be generated in a real-time state without relying on a complex and low-efficiency calculation module, thereby greatly improving fineness of a video picture and efficiency of video data generation. Although the following describes the present disclosure mainly by using a mouth as an example, a person skilled in the art is to understand that the solutions of the present disclosure may be applicable to generation of any facial organ related to expression and emotion transmission. Certainly, the present disclosure is not limited thereto.

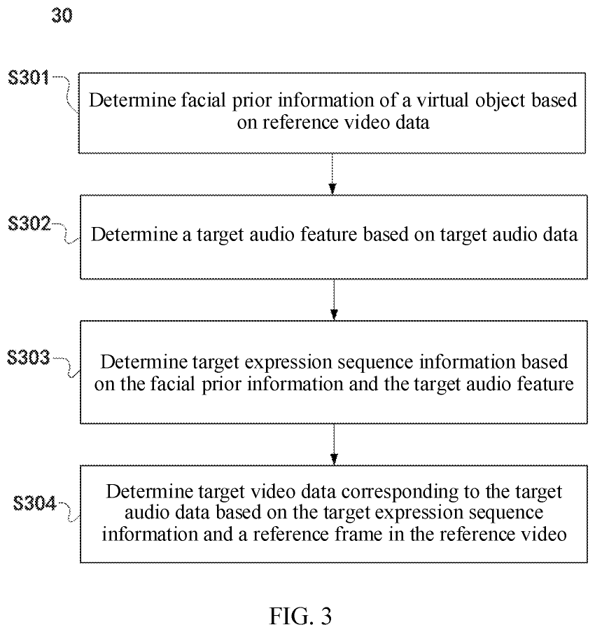

FIG. 3 is a flowchart of an audio data processing method 30 according to some embodiments of the present disclosure.

The method 30 may be performed at a terminal device or a server (such as the terminal device 120 or the server 110 as shown in FIG. 1). The method 30 includes operation S301 to operation S304 in the following. Certainly, the method 30 may alternatively include more or fewer operations. The present disclosure is not limited thereto.

In some embodiments, operations S301 and S302 are operations at a preprocessing stage, and may be performed by any facial information extraction model. At a transformation stage from audio information to expression information, operation S303 may be performed, and at an expression-to-video frame reconstruction stage, operation S304 may be performed.

In operation S301, facial prior information of a virtual object is determined based on reference video data.

In some embodiments, video content related to the reference video data includes the virtual object. The virtual object is an object that has a face and can vocalize, for example, may be a real person or animal, or may be a cartoon image or a virtual three-dimensional model. The reference video data may be obtained by capturing a real scenario by using a video acquisition device, or may be generated by using software.

The reference video data may be inputted video data shown in FIG. 2. In the inputted video data, the virtual object says “The weather is really nice today”. The video data includes a plurality of reference video frames, and each reference video frame is an image. A head of the virtual object is presented in the image.

The facial prior information of the virtual object is accurate facial information configured for identifying a face of the virtual object, which is configured for reflecting a facial feature of the virtual object. In some embodiments, the facial prior information of the virtual object includes one or more of the following: reference facial shape information, reference expression information, and reference head pose information. Certainly, the present disclosure is not limited thereto.

For example, the reference facial shape information may be information configured for characterizing a facial shape feature of the virtual object. In some embodiments, the reference facial shape information may be extracted from any reference video frame, which may include facial texture and 3D facial shape information of the virtual object. In some embodiments, based on the reference facial shape information, an expressionless 3D facial avatar of the virtual object may be obtained by directly performing an affine transformation on a universal 3D standard virtual object. The 3D standard virtual object is also referred to as an untextured virtual object, which is a standardized model configured to simulate human facial expressions and actions. These models usually have a uniform three-dimensional shape and structure, which are configured to represent a basic appearance of a virtual object. Certainly, the present disclosure is not limited thereto.

For example, the reference expression information may be any information configured for characterizing an expression characteristic of the virtual object, which is configured for reflecting expression characteristics of the virtual object under different language expression emotions. The reference expression information may be extracted from each reference video frame, to obtain a reference expression feature vector Bi corresponding to each reference video frame i. The reference expression information may refer to a set of reference expression feature vectors corresponding to all reference video frames. In some embodiments, based on the reference expression feature vector and the reference facial shape information, the 3D facial avatar of the virtual object under a specific expression in a frame may be obtained by directly performing the affine transformation on the universal 3D standard virtual object. Certainly, the present disclosure is not limited thereto.

For example, the reference head pose information is any information configured for characterizing a pose characteristic of the head of the virtual object. The reference head pose information is extracted from each reference video frame, to obtain a reference head pose feature vector corresponding to each reference video frame i. The reference head pose information may refer to a set of reference head pose feature vectors corresponding to all reference video frames. In some embodiments, based on the reference head pose feature vector, the universal 3D standard virtual object can be directly adjusted by rotation to reach a head pose corresponding to the reference head pose feature vector. Certainly, the present disclosure is not limited thereto.

In operation S302, a target audio feature is determined based on target audio data.

Audio identified by the target audio data is audio on which audio-virtual object synthesis needs to be performed, e.g., audio that needs to be vocalized by the virtual object in the target video data determined in subsequent S304. In some embodiments, the target audio data may be the target audio data shown in FIG. 2. Audio corresponding to the inputted video data is “I love you”. The target audio data may include a plurality of audio frames, and the target audio feature refers to a sound-related feature extracted from these audio frames. Features may include spectrum information, time domain information, sound strength, and the like of an audio signal. Certainly, the present disclosure is not limited thereto.

In operation S303, target expression sequence information is determined based on the facial prior information and the target audio feature.

In some embodiments, the target expression sequence information may be reference expression information corresponding to the target audio feature. The target expression sequence information is a set of target expression feature vectors arranged in time sequence. Each target expression feature vector corresponds to a target audio frame and is configured for reflecting an expression characteristic of the virtual object when the virtual object says a specific sentence. Such a mapping relationship may be in a many-to-one, one-to-one, or one-to-many form. For example, one target expression feature vector may correspond to one target audio frame, or may correspond to a plurality of target audio frames, or even a plurality of target expression feature vectors may correspond to a single target audio frame. Certainly, the present disclosure is not limited thereto.

In some embodiments, the target expression sequence information may be directly determined only based on the reference facial shape information and the reference expression information in the facial prior information and with reference to the target audio feature. Certainly, the present disclosure is not limited thereto.

In operation S304, target video data corresponding to the target audio data is determined based on the target expression sequence information and a reference frame in the reference video data.

A virtual object in the target video data and the virtual object in the reference video data in S301 are the same virtual object. However, the virtual object in the target video data may emit audio corresponding to the target audio data.

Because the target expression sequence information can accurately identify an expression feature of the virtual object when the virtual object emits the audio corresponding to the target audio feature, and the reference frame can identify related information of the virtual object, by using the target expression sequence information, a facial condition of the virtual object emitting the audio corresponding to the target audio data can be accurately simulated based on guidance of the reference frame in the reference video data, thereby obtaining the target video data.

In some embodiments, a quantity of target video frames in the target video data may match a quantity of audio frames in the target audio data. Each target video frame displays a specific facial expression of the virtual object when speaking a corresponding audio frame. In some embodiments, a mouth movement (e.g., a mouse shape) of the virtual object when speaking the corresponding audio frame is to correspond to pronunciation of the audio frame. The facial expression of the virtual object displayed in the target video frame is consistent with pronunciation, thereby making a generated video more authentic and realistic.

In some embodiments, the reference frame Iᵣ in the reference video data may be any video frame in the reference video data, which is configured for providing a basic shape and texture of the virtual object as reference information at the expression-to-video frame reconstruction stage. For example, in a generation process of each target video frame in the target video data, the same reference frame Iᵣ may be used, or different reference frames may be used. The present disclosure is not limited thereto.

In some embodiments, in S304, a source video frame may be extracted from the reference video data. The source video frame is masked based on the target expression sequence, to obtain a first video frame. In the first video frame, some facial components of the virtual object are replaced with black pixel blocks. The target video data corresponding to the target audio data is determined based on the first video frame and the reference frame by using the facial prior information.

A relationship between the reference frame and the source video frame is not limited in the present disclosure. For example, the source video frame may be one or some reference frames. A quantity of source video frames used when determining the target video data is not limited in the present disclosure. For example, one source video frame or a plurality of source video frames may be used.

In some embodiments, masking the source video frame based on the target expression sequence, to obtain the first video frame includes: determining, based on the target expression sequence and the reference facial shape information, a pixel region corresponding to the some facial components of the virtual object in the source video frame; and modifying pixel values in the pixel region to a preset value.

In some embodiments, determining the target video data corresponding to the target audio data based on the first video frame and the reference frame by using the facial prior information includes: encoding the first video frame and the reference frame by using a shared-weight encoder, to obtain an encoded feature of the first video frame and an encoded feature of the reference frame; and decoding the encoded feature of the first video frame and the encoded feature of the reference frame based on the facial prior information and the target expression sequence by using a decoder, to obtain the target video data corresponding to the target audio data, the target video data including the target video frame, and the target video frame including a predicted value of the some facial components of the virtual object that is replaced with black pixel blocks.

For example, the first video frame Iₛ^{m} may be generated based on the target expression sequence information (where facial components in the first video frame Iₛ^{m} are masked, e.g., the facial components in the video frame are replaced with black pixel blocks). Then, the target video frame Îₛ is determined based on the source video frame Iₛ and the reference frame Iᵣ. The following is described by using a mask of a mouth component (also referred to as a mouth mask) as an example. A person skilled in the art may understand that the solution may also be applicable to any facial component.

For example, for each video frame, a facial structure related to the mouth movement is masked (for example, a lower half of a face) by using the mouth mask, and a facial variable structure unrelated to an expression change or the target audio frame is preserved. Next, by using the reference frame Iᵣ in the reference video data and a video frame including a learnable mouth mask, a facial identity alignment module is used to predict a pixel value at the mouth mask, and the target video frame is filled with the predicted pixel value at the mouth mask, to obtain the target video frame. The present disclosure is not limited thereto.

In some embodiments, a facial identity alignment operation is further performed in operation S304. The facial identity alignment module having a cross-attention structure is used to establish an effective connection between a target expression related parameter (for example, the target expression feature vector) and effective facial texture of a single reference frame. Through this structure, the module can implement more precise lip shape control. For example, the cross-attention structure allows the module to pay attention to both the target expression and facial texture information extracted from the single reference frame. This attention mechanism enables the module to precisely adjust lip shape and movement based on the target expression feature vector and the facial texture of the reference frame. By combining the two types of information, the module can better understand a feature and a structure of the face, and precisely control the lip movement.

The method according to some embodiments of the present disclosure can improve accuracy and credibility of the lip action of the virtual object, and enhance a video communication effect and visual expressiveness. In some embodiments of the present disclosure, fine details of facial organs can be generated in a real-time state without relying on a complex and low-efficiency calculation module, thereby greatly improving fineness of a video picture and efficiency of video data generation.

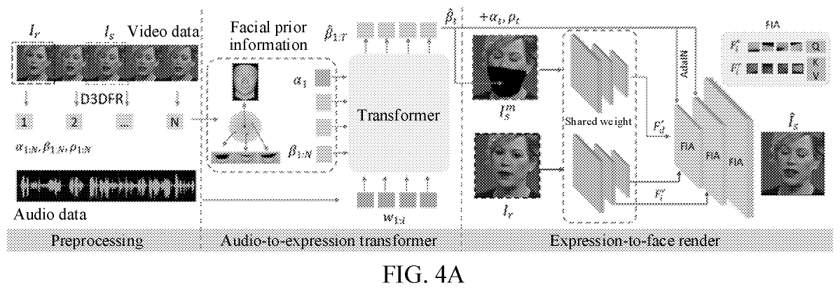

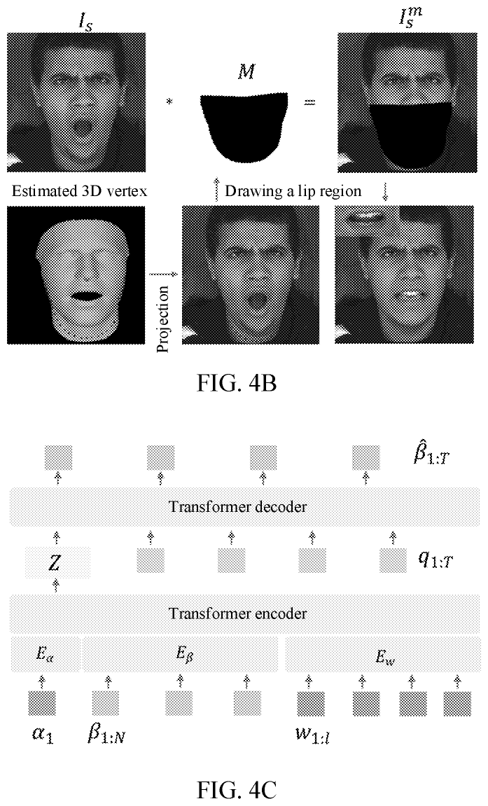

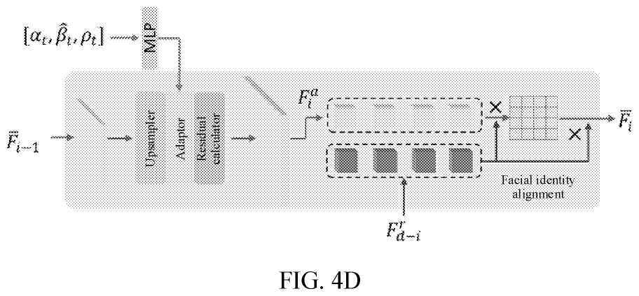

FIG. 4A is a schematic diagram of an improved neural network model according to some embodiments of the present disclosure. FIG. 4B is a schematic diagram of an audio-to-expression transformation stage according to some embodiments of the present disclosure. FIG. 4C is a schematic diagram of an audio-to-expression transformer according to some embodiments of the present disclosure. FIG. 4D is a schematic diagram of an expression-to-face renderer according to some embodiments of the present disclosure.

As shown in FIG. 4A, at a preprocessing stage, a deep 3D facial reconstruction model may be configured to perform operation S301, to determine facial prior information of a virtual object based on reference video data. The facial prior information includes reference facial shape information (α₁), reference expression information (β₁, . . . , β_{N}), and reference head pose information (ρ₁, . . . , ρ_{N}). Given a series of video frames including a face of the virtual object, the deep 3D facial reconstruction model can extract 3D coefficients, including a shape coefficient, an expression coefficient, and a pose coefficient. In some embodiments, the deep 3D facial reconstruction model may perform weakly supervised learning by using a hybrid loss function. The hybrid loss function considers low-level and perceptual-level information for supervision. In addition or alternatively, the deep 3D facial reconstruction model may further perform multi-image facial reconstruction by using complementary information from different images, thereby implementing shape aggregation. The deep 3D facial reconstruction model is characterized by speed, accuracy, and robustness, and can deal with cases of occlusion and a large pose. Nevertheless, embodiments of the present disclosure may alternatively use another neural network model to extract the facial prior information of the virtual object.

In some embodiments, in operation S302, self-supervised speech representation learning may be performed by using a Bert model (also referred to as a HuBert model below) of a hidden unit. By predicting a mask of the hidden unit, a target audio feature (w₁, . . . , wₗ) is determined based on target audio data. The Hubert model adopts a self-supervised learning method, which learns high-quality speech representation by predicting the hidden unit through the mask. Nevertheless, the embodiments of the present disclosure may alternatively use another neural network model to determine the target audio feature.

At a stage of transforming from audio information to expression information, in operation S303, with reference to 1 target audio features (w₁, . . . , wₗ), the audio-to-expression transformer may utilize a piece of reference facial shape information (α₁) and N pieces of reference expression information (β₁, . . . , β_{N}) in the 3D coefficients to obtain target expression sequence information, the target expression sequence information including T target expression features (\hat{β}₁, . . . , \hat{β}_{T}). N, 1, and T may be the same value or different values. This is not limited in the present disclosure.

For example, each virtual object has a unique individual facial and mouth structure, while also exhibiting a distinct speech pattern. In this case, the facial prior information including the reference facial shape information (α₁) and N pieces of reference expression information (β₁, . . . , β_{N}) can reflect a personality feature or an identity feature of the virtual object. For example, the reference facial shape information (α₁) characterizes the identity of the virtual object through facial texture and shape characteristics. In some embodiments, the reference facial shape information may be associated with a natural facial dimension and an oral proportion. In addition or alternatively, the reference expression information captures an individual unique speaking style, which provides a personalized virtual object with a difference from a standard shape. The reference expression information includes factors such as an amplitude of a mouth movement and emotional expression. By comprehensively using the information, a facial expression sequence matching target audio can be more accurately generated, so that an expression of the virtual object is more vivid and natural.

As shown in FIG. 4A, the audio-to-expression transformer is based on a transformer architecture, and includes an encoder and a decoder. Under such an architecture, when the facial prior information includes the reference facial shape information and the reference expression information, an operation of determining the target expression sequence information may include: encoding the reference facial shape information (α₁), the reference expression information (β₁, . . . , β_{N}), and the target audio feature (w₁, . . . , wₗ), to obtain a hidden vector (Z); and decoding the hidden vector (Z), to determine the target expression sequence information. FIG. 4B further shows some details of the audio-to-expression transformer.

By encoding the reference facial shape information and the reference expression information with reference to the target audio feature, relevant information such as a facial shape and an expression related to the virtual object can be accurately associated with different audio related to the target audio feature, so that obtained target expression sequence information can more naturally identify the facial expression of the virtual object when the virtual object emits the target audio feature.

For example, the reference facial shape information α₁ (which is used as default reference facial shape information), N pieces of reference expression information (β₁, . . . , β_{N}), and I target audio features (w₁, . . . , wₗ) in the 3D coefficients can respectively obtain embedding vectors through a fully connected network. Then, the embedding vectors are connected in chronological order, to obtain a total of 1+N+1 tokens, and the tokens are inputted into a multi-head self-attention (MHSA) (e.g., a transformer encoder) for encoding, to obtain a hidden vector Z.

$$Z = MHSA ( {α}_{1} , {β}_{1} , … , {β}_{N} , {w}_{1} , … , {w}_{l} ) \qquad ( 1 )$$

An expression query vector (qₜ) (initially set to zero) is combined with the hidden vector Z, and is fed to a multi-head cross-attention (MHCA) network (e.g., a transformer decoder) for decoding, to obtain T target expression features (\hat{β}₁, . . . , \hat{β}_{T}).

$${\hat{β}}_{1} , … , {\hat{β}}_{T} = MHCA ( {q}_{1} , {q}_{2} , … , qr , Z ) \qquad ( 2 )$$

At a stage of reconstructing the expression information and the video data, in operation S304, the expression-to-face renderer first obtains any reference video frame from the reference video data as a source video frame Iₛ. For example, assuming that an m^{th} target video frame needs to be generated, an m^{th} reference video frame may be extracted from the reference video data as the source video frame. Certainly, the present disclosure is not limited thereto.

Next, the expression-to-face renderer may generate a first video frame

$${I}_{s}^{m}$$

based on a target expression feature vector \hat{β}ₜ in the target expression sequence information and the source video frame Iₛ, and facial components in the first video frame

$${I}_{s}^{m}$$

are masked. In some embodiments, a region corresponding to the masked facial components is learnable. In some examples, a size and a shape of the region may be associated with the expression information and the identity information of the virtual object.

In some embodiments, different from a method, a process of generating the first video frame

$${I}_{s}^{m}$$

is learnable. As shown in FIG. 4B, the source video frame Iₛ may be selectively masked, which allows more accurate control over modification of a facial component region. First, a 3D vertex is estimated based on a predicted expression feature vector, and then the 3D vertex is projected to an image. Then, based on 3D vertexes, mouth and neck regions may be rendered and filled with black pixel blocks (or pixel blocks with any preset pixel value). To be specific, compared with the source video frame, the first video frame has a masked region which belongs to the source video frame on which masking processing is performed. The masked region of the first video frame may be black pixel blocks. This region of the source video frame includes some facial components of the virtual object.

A process of generating the mask is as follows:

$${V}_{x y} = P ( V ( {α}_{t} , {\hat{β}}_{t} , {ρ}_{t} ) , {τ}_{t} ) \qquad ( 3 )$$

$$M = C ( {V}_{x y} ) , ( x , y ) ∈ S$$

$${I}_{s}^{m} = M * {I}_{s}$$

P is a projection function, and τₜ indicates a translation matrix of t. C is a function that solves for a contour of vertexes V_{xy} in facial and neck regions of interest, and a set of points V_{xy} is S.

By masking the source video frame, a facial region that needs to be predicted can be accurately identified, and the region is directly correlated with the target audio feature emitted by the virtual object, thereby improving pertinence and accuracy of prediction.

The first video frame

$${I}_{s}^{m}$$

and a reference frame Iᵣ in the reference video data are jointly inputted to a shared-weight encoder, to process two images to extract multi-scale features. For example, the shared-weight encoder encodes the first video frame

$${I}_{s}^{m}$$

as a feature Fₛ and encodes the reference frame Iᵣ is as a feature Fᵣ.

In some embodiments, as shown in FIG. 4A, the shared-weight encoder includes d stacked residual blocks. Therefore, the encoder is also referred to as a d-level encoder. At each level (residual block), image resolution is halved, and an extracted feature dimension is increased. In this way, the multi-scale features can be effectively extracted from the shared-weight encoder. Because a weight of the encoder is shared, the first video frame

$${I}_{s}^{m}$$

and the reference name Iᵣ can be encoded in parallel. For example, the encoder extracts features of various scales from an inputted image through a plurality of levels of processing. A multi-scale feature of an i^{th} level of the d-level encoder may be calculated as follows.

$${F}_{i}^{s} , {F}_{i}^{r} = S {E}_{i} ( [ {F}_{i - 1}^{s} , {F}_{i - 1}^{r} ] ) \qquad ( 4 )$$

SEᵢ represents the i^{th} level of the encoder. At an end of each level of processing, a representation including features of different scales and abstraction levels is obtained. The features can capture different details and structure information of the inputted image. Thus, a set of d-dimensional feature vectors, to be specific,

$${F}_{s} = [ {F}_{1}^{s} , … , {F}_{d}^{s} ] and$$

$${F}_{r} = [ {F}_{1}^{r} , … , {F}_{d}^{r} ] ,$$

is obtained for the first video frame

$${I}_{s}^{m}$$

and the reference frame Iᵣ. Because the first video frame

$${I}_{s}^{m}$$

and the reference frame Iᵣ share the weight of the encoder, the encoder can process the source video frame and the reference frame more efficiently, and extract a feature representation shared by the source video frame and the reference frame. This parallel computing mode not only accelerates a processing speed, but also ensures that feature representations of the source video frame and the reference frame are compared in the same space, thereby facilitating subsequent matching and fusion.

Next, the expression-to-face renderer decodes a feature Fₛ corresponding to the first video frame

$${I}_{s}^{m}$$

and a feature Fᵣ corresponding to the reference frame Iᵣ by using a decoder including a facial identity alignment module, to obtain the target video frame.

As can be seen, in a process of performing reasoning by using the improved neural network, an operation of first determining a target expression sequence and then predicting a video frame based on the target expression sequence significantly improves synchronization between audio content and a facial component action of the virtual object on a screen. This method not only enhances the sense of reality of a facial action, but also can accurately reflect an identity characteristic of the virtual object. The method ensures operation efficiency and stability of a neural network while improving performance, which is applicable to real-time video generation.

FIG. 4D shows more exemplary details of the decoder. For example, the decoder includes d stacked decoding layers, and therefore, the decoder is also referred to as the d-level decoder. For example, the decoder includes d decoding layers, an input of each decoding layer includes an output of a previous decoding layer, the facial prior information, and the encoded feature of the reference frame, and an output of each decoding layer is a predicted value of the target video frame. It is assumed that an input feature of each level of the decoder is F̅ᵢ₋₁, and an output feature is F̅ᵢ.

As shown in FIG. 4D, the 3D coefficients {αₜ, \hat{β}ₜ, ρₜ} undergo dimensionality mapping through a three-layer MLP before being fused into the decoder through an AdalN module. This process aims to map the 3D coefficients to a feature space compatible with a decoder network, to facilitate a subsequent feature fusion and generation process. Therefore, the input feature F̅ᵢ₋₁ of each level of the decoder are first upsampled to increase resolution, to obtain a feature

$${F}_{i}^{u} .$$

The feature

$${F}_{i}^{u}$$

is then modulated by using the 3D coefficients {αₜ, \hat{β}ₜ, ρₜ}, to match a shape of a specific facial component, thereby better controlling a facial component movement and facial expression generation. The modulated feature is aligned with the feature

$${F}_{d - i}^{r}$$

from the reference frame Iᵣ at the same resolution, and the two are fused to control facial generation and texture aggregation. The foregoing process may be described as follows.

$${\overline{F}}_{i} = {FIA}_{i} ( [ {α}_{t} , {\hat{β}}_{t} , {ρ}_{t} ] , {\overline{F}}_{i - 1} , {F}_{d - i}^{r} ) \qquad ( 5 )$$

FIAᵢ is a level (or a layer) of decoding layer in the decoder including the facial identity alignment module.

In addition or alternatively, to avoid generating unnecessary background in the target video frame and ensure a more realistic and precise final result, a fusion policy may be further adopted. For example, in some embodiments of the present disclosure, an outputted result of the last decoding layer of the decoder may be fused with an output of the first decoding layer of the decoder, to obtain a final output. The fusion policy aims to retain only pixels corresponding to predicted facial components, and eliminate background interference, so that a generated image is clearer and concentrates on the facial feature. The process may be described as follows.

$${\hat{I}}_{s} = M * {I}_{s} + ( 1 - M ) * {\overline{F}}_{d} \qquad ( 6 )$$

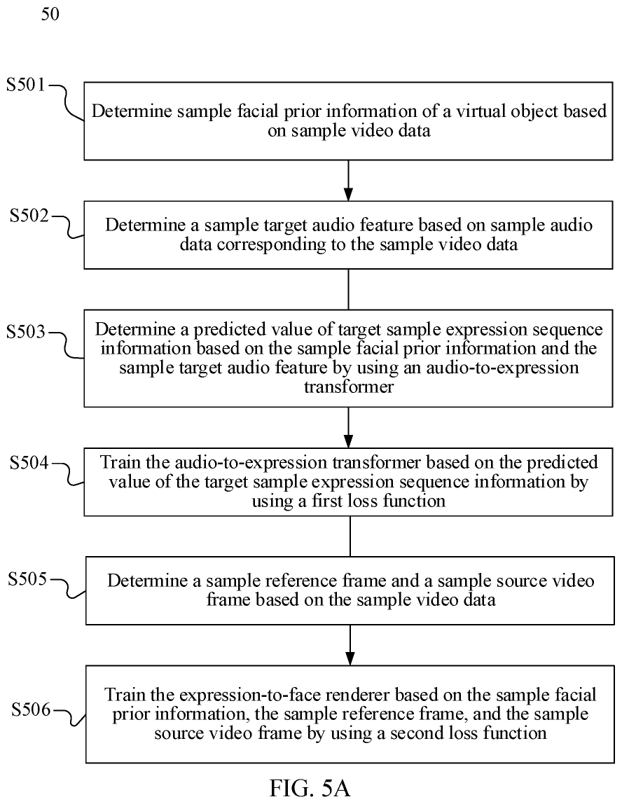

FIG. 5A is a flowchart of a neural network training method 50 according to some embodiments of the present disclosure, which can train the improved neural network model shown in FIG. 4A to FIG. 4C. FIG. 5B is a schematic diagram of training an audio-to-expression transformer according to some embodiments of the present disclosure.

The method 50 may be performed at a terminal device or a server (such as the terminal device 120 or the server 110 as shown in FIG. 1). The method 50 includes operation S501 to operation S506 in the following. Certainly, the method 50 may alternatively include more or fewer operations. The present disclosure is not limited thereto.

In operation S501, sample facial prior information of a virtual object is determined based on sample video data. In operation S502, a sample target audio feature is determined based on sample audio data corresponding to the sample video data.

For example, it is assumed that the facial prior information obtained based on the sample video data includes: sample facial shape information (α₁), sample target expression sequence information (for example, sample expression information β₁, . . . , β_{N}), and sample head pose information (ρ₁, . . . , ρ_{N}). The facial prior information may be directly obtained through preprocessing. Such facial prior information may be used as an actual value of facial prior information of the virtual object. A preprocessing process has been described in detail in the foregoing, and details are not described herein again in the present disclosure.

Next, with reference to the foregoing detailed preprocessing process, the sample audio data corresponding to the sample video data may further be extracted to directly determine a sample target audio feature corresponding to the sample audio data. The sample audio data corresponding to the sample video data herein refers to, for example, audio data including a speech segment of “The weather is really nice today” when a virtual person is saying “The weather is really nice today” in the sample video data.

Next, a training process of the audio-to-expression transformer is described based on operations S503 and S504. A person skilled in the art is to understand that the present disclosure is not limited thereto.

In operation S503, a predicted value of target sample expression sequence information is determined based on the sample facial prior information and the sample target audio feature by using the audio-to-expression transformer. In operation S504, the audio-to-expression transformer is trained based on the predicted value of the target sample expression sequence information by using a first loss function. In some embodiments, the sample facial prior information may include an actual value of sample target expression sequence information, and operation S503 includes: masking the actual value of the facial prior information of the virtual object to obtain masked facial prior information of the virtual object; and determining a predicted value of the sample target expression sequence information of facial prior information of the virtual object based on the masked facial prior information of the virtual object and the sample target audio feature by using the audio-to-expression transformer. Certainly, the present disclosure is not limited thereto.

In some embodiments, to determine the predicted value of the sample target expression sequence information of the virtual object, the actual value of the sample target expression sequence information needs to be masked first, to obtain masked sample target expression sequence information of the virtual object. This process includes hiding or masking a part of information in the actual value, thereby generating a version with a mask. The masked information may be masked according to a specific condition or rule, for example, specific reference expression information βt is hidden. Next, based on the masked sample target expression sequence information (e.g., facial prior information excluding the specific reference expression information βₜ) and the sample target audio feature, the audio-to-expression transformer during training may be configured to predict a predicted value (for example, \hat{β}ₜ) of a masked part of the sample target expression sequence information of the virtual object. An objective of training the audio-to-expression transformer is to ensure that the actual value βₜ of the facial prior information is sufficiently close to the predicted value \hat{β}ₜ. Therefore, parameters of neurons in the audio-to-expression transformer may be constantly adjusted to maximize the first loss function. Certainly, the present disclosure is not limited thereto.

In some embodiments, as shown in FIG. 5B, the first loss function configured for training the audio-to-expression transformer may include, but is not limited to, a mean square error (MSE) loss and a 3D vertex loss.

For example, the mean square error (MSE) loss is configured for calculating an error between a predicted value and an actual value of an expression feature vector. It is assumed that a predicted expression feature vector is \hat{β}ₜ, and an actual expression feature vector is βₜ. The MSE loss may be represented as:

$${L}_{M S E} = \frac{1}{T} {\sum }_{t = 1}^{T} {‖ {β}_{t} - {\hat{β}}_{t} ‖}_{2}^{2} \qquad ( 7 )$$

In some embodiments, the 3D vertex loss calculates predicted locations of 3D vertexes by combining the predicted expression feature vector \hat{β}, the facial shape information α₁, and the reference head pose information ρ. The vertexes are key points (for example, mouth corners) selected from a facial region (for example, a mouth), and are configured for evaluating distances between actual values and predicted values of the key points of the facial region. By minimizing a difference between a predicted value and an actual value of a position of a key point, it is possible to ensure that a generated 3D vertex is accurately aligned with a key point of the mouth. Let V represent a 3D vertex calculated from a coefficient. The 3D vertex loss Lᵥ may be described as follows:

$${L}_{V} = \frac{1}{T} {\sum }_{t = 1}^{T} {‖ V ( {α}_{t} , {β}_{t} , {ρ}_{t} ) - V ( {α}_{t} , {\hat{β}}_{t} , {ρ}_{t} ) ‖}_{2}^{2} \qquad ( 8 )$$

Therefore, the first loss function may be expressed as Lₐ₂ₑ=L_{MSE}+0.1*C_{V}. 0.1 is a hyperparameter, and may alternatively be set to any other value. The present disclosure is not limited thereto.

Next, a training process of an expression-to-face renderer is described based on operations S505 and S506. A person skilled in the art is to understand that the present disclosure is not limited thereto. The training process of the audio-to-expression transformer and the training process of the expression-to-face renderer may be independent of each other. For example, as described in detail below, inputted data used in the training process of the expression-to-face renderer may be the sample facial prior information (which may include the actual value of the sample target expression sequence information), the sample reference frame, and the sample source video frame. The inputted data may all be obtained in the preprocessing process (to be specific, operations S501 and S502) without a need to be processed by the audio-to-expression transformer. Certainly, in some other embodiments, the audio-to-expression transformer and the expression-to-face renderer may alternatively be jointly trained. This is not limited in the present disclosure.

For example, the sample facial prior information includes the actual value of the sample target expression sequence information. In operation S505, the sample reference frame and the sample source video frame are determined based on the sample video data. Next, in operation S506, the expression-to-face renderer is trained based on the sample facial prior information, the sample reference frame, and the sample source video frame by using a second loss function.

In some embodiments, in operation S506, the sample source video frame is masked based on an actual value of a target expression sequence, to obtain a masked sample source video frame. A predicted value of the sample source video frame is determined for the masked sample source video frame based on the sample facial prior information, the sample reference frame, and the actual value of the sample target expression sequence information by using the expression-to-face renderer. The expression-to-face renderer is trained based on the predicted value and an actual value of the sample source video frame by using the second loss function, the second loss function including one or a combination of more of the following: a pixel loss, a perceptual loss, an adversarial loss, and a local pixel loss.

In some embodiments, the sample facial prior information includes 3D coefficients {αₜ, \hat{β}ₜ, ρₜ}. Reference may be made to the foregoing detailed method. First, the sample source video frame may be masked (to be specific, the masked sample source video frame is obtained, facial components of which are replaced with black pixel blocks). Then, the predicted value of the sample source video frame is determined based on the 3D coefficients and the sample reference frame. An objective of training the expression-to-face renderer is to ensure that the actual value of the sample source video frame is sufficiently close to the predicted value. Therefore, parameters of neurons in the expression-to-face renderer may be constantly adjusted to maximize the second loss function. Certainly, the present disclosure is not limited thereto.

In some embodiments, the second loss function configured for training an expression-to-face renderer may use a combination of a plurality of loss functions to constrain synchronization between the facial component and an expression, to improve visual quality of a generated video frame.

For example, the pixel loss may be configured for measuring a pixel-level difference between a generated image and a target image. By minimizing a pixel difference between the predicted value Îₛ and the actual value Iₛ of the sample source video frame, accuracy and clarity of the generated video frame are enhanced. In an example, the pixel loss L₁ may be calculated as: L₁=Σ∥Îₛ−Iₛ∥ₗ. Certainly, the present disclosure is not limited thereto.

For example, the perceptual loss measures a perceptual difference between the predicted value Îₛ and the actual value Iₛ of the generated sample source video frame based on a feature (e.g., perceptual information obtained from an image) extracted by a deep learning model (for example, a VGG network). The perceptual loss helps improve realism and naturalness of the generated image, to better match a target expression. The perceptual loss may be calculated as: L₂=Σ∥VGG(Îₛ)−VGG(Iₛ)∥ₗ.

For example, the adversarial loss evaluates authenticity of the predicted value of the sample source video frame through a discriminator network within a generative adversarial network (GAN) framework. A generator network is intended to deceive a discriminator from distinguishing the predicted value Îs and the actual value Iₛ of the sample source video frame, thereby improving authenticity and vividness of the image. The adversarial loss may be calculated as: L₃=E_{I}_{ₛ}[log D(Iₛ)+log (1−D(Îₛ))]. D(·) represents the discriminator.

For example, the local pixel loss focuses on enhancing pixel-level details of a specific region, for example, details of the mouth. By introducing an additional loss term for a specific facial region, the generated image is clearer and more vivid in details such as the mouth. The local pixel loss may be calculated as: L₄=Σ∥M′*Îₛ−M′*Iₛ∥₁. M′ represents a binary mask of a target facial region.

The second loss function is obtained by performing a weighted sum of the foregoing loss functions. The foregoing loss functions act together in a training process of the expression-to-video renderer, to ensure that a generated video can accurately reflect the target expression while maintaining high-level visual quality and details. The second loss function may be calculated as L_{e2f}=λ₁*L₁+λ₂*L₂+λ₃*L₃+λ₄*L₄, where λ₁=1, λ₂=1, λ₃=0.1, λ₄=1. λ₁ to λ₄ are all hyperparameters, and may be set to any other value in an actual application. The present disclosure is not limited thereto.

In a training process of the improved neural network model, an improved first loss function and an improved second loss function may be introduced. The two loss functions respectively optimize different aspects of characteristics. By adjusting a neural network parameter, performance of a trained neural network is improved. The first loss function and the second loss function may enable a neural network to learn and adapt to a feature of the inputted data more effectively, and optimize the neural network in a plurality aspects in the training process. This loss function design in which different characteristics are comprehensively considered helps improve a generalization capability and training efficiency of the neural network, thereby improving performance of the neural network in an actual application.

Some embodiments of the present disclosure further provides an audio data processing apparatus. The apparatus includes: a first preprocessing module, configured to determine facial prior information of a virtual object based on reference video data; a second preprocessing module, configured to determine a target audio feature based on target audio data; an audio-to-expression transformer module, configured to determine target expression sequence information based on the facial prior information and the target audio feature; and an expression-to-face renderer, configured to determine target video data corresponding to the target audio data based on the target expression sequence information and a reference frame in the reference video data.

In some embodiments, the facial prior information includes one or more of the following: reference facial shape information, reference expression information, and reference head pose information.

In some embodiments, when the facial prior information includes the reference facial shape information and the reference expression information, the audio-to-expression transformer module is further configured to:
encode the reference facial shape information, the reference expression information, and the target audio feature to obtain a hidden vector; and
decode the hidden vector to determine the target expression sequence information.

In some embodiments, the expression-to-face renderer is further configured to:
extract a source video frame from the reference video data;
mask the source video frame based on a target expression sequence, to obtain a first video frame, some facial components of the virtual object being replaced with black pixel blocks in the first video frame; and
determine the target video data corresponding to the target audio data based on the first video frame and the reference frame by using the facial prior information.

In some embodiments, the expression-to-face renderer is further configured to:
determine, based on the target expression sequence and the reference facial shape information, a pixel region corresponding to the some facial components of the virtual object in the source video frame; and
modify pixel values in the pixel region to a preset value, to obtain the first video frame.

In some embodiments, the expression-to-face renderer is further configured to:
encode the first video frame and the reference frame by using a shared-weight encoder, to obtain a first encoded feature of the first video frame and a second encoded feature of the reference frame; and
decode the first encoded feature and the second encoded feature based on the facial prior information and the target expression sequence by using a decoder, to obtain the target video data corresponding to the target audio data, the target video data including a target video frame, and a region of black pixel blocks in the target video frame being replaced with a predicted value of the some facial components of the virtual object.

In some embodiments, the decoder includes a plurality of cascaded decoding layers, an input of each decoding layer includes an output of a previous decoding layer, the facial prior information, and an encoded feature of the reference frame, and an output of each decoding layer is a predicted value of the target video frame.

As can be seen, the facial prior information of the virtual object in the reference video data is determined, so that a facial characteristic of the virtual object can be accurately identified, thereby determining, based on the facial prior information and the target audio feature, the target expression sequence information that conforms to the facial characteristic of the virtual object and naturally integrates the facial characteristic. When the target video data is determined based on the target expression sequence information and the reference frame, synchronization precision between audio content in the target video data and a facial component (for example, a mouth) action of the virtual object on a screen can be significantly improved, and a sense of reality of a mouth action is enhanced. In addition or alternatively, an identity characteristic of the virtual object can be accurately reflected, and an expression difference between individuals is captured and reproduced more accurately. Moreover, overall operation efficiency and stability are ensured while system performance is improved. This is especially applicable to real-time video generation.

Some embodiments of the present disclosure further provides a neural network training apparatus, a neural network including an audio-to-expression transformer and an expression-to-face renderer, and the apparatus including:
a first determining module, configured to determine sample facial prior information of a virtual object based on sample video data;
a second determining module, configured to determine a sample target audio feature based on sample audio data corresponding to the sample video data;
a third determining module, configured to determine a predicted value of target sample expression sequence information based on the sample facial prior information and the sample target audio feature by using the audio-to-expression transformer;
a first training module, configured to train the audio-to-expression transformer based on the predicted value of the target sample expression sequence information by using a first loss function;
a fourth determining module, configured to determine a sample reference frame and a sample source video frame based on the sample video data; and
a second training module, configured to train the expression-to-face renderer based on the sample facial prior information, the sample reference frame, and the sample source video frame by using a second loss function.

In some embodiments, the sample facial prior information includes an actual value of sample target expression sequence information, and the third determining module is further configured to:
mask an actual value of facial prior information of the virtual object to obtain masked facial prior information of the virtual object; and
determine a predicted value of the sample target expression sequence information of the virtual object based on the masked facial prior information of the virtual object and a sample target audio feature by using the audio-to-expression transformer.

In some embodiments, the sample facial prior information includes the actual value of the sample target expression sequence information, and the second training module is further configured to:
mask the sample source video frame based on an actual value of a sample target expression sequence, to obtain a masked sample source video frame;
determine a predicted value of the sample source video frame for the masked sample source video frame based on the sample facial prior information and the sample reference frame by using the expression-to-face renderer; and
train the expression-to-face renderer based on the predicted value and an actual value of the sample source video frame by using the second loss function,
the second loss function including one or a combination of more of the following: a pixel loss, a perceptual loss, an adversarial loss, and a local pixel loss.

As can be seen, in a training process of an improved neural network model, an improved first loss function and an improved second loss function may be introduced. The two loss functions respectively optimize different aspects of characteristics. By adjusting a neural network parameter, performance of the trained neural network is improved. The first loss function and the second loss function may enable the neural network to learn and adapt to a feature of inputted data more effectively, and optimize the neural network in a plurality aspects in a training process. This loss function design in which different characteristics are comprehensively considered helps improve a generalization capability and training efficiency of the neural network, thereby improving performance of the neural network in an actual application.

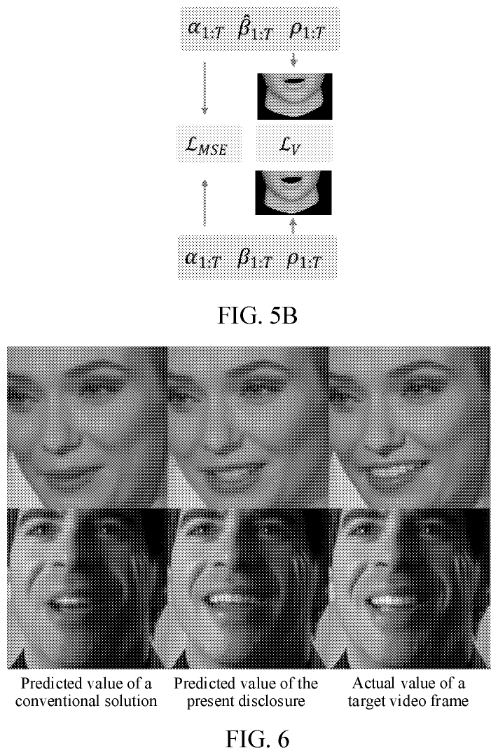

As shown in FIG. 6, a predicted result of a video frame obtained according to the solution of some embodiments of the present disclosure is very close to a real result of the video frame, and a level of detail and texture reproduction is much higher than that of a solution.

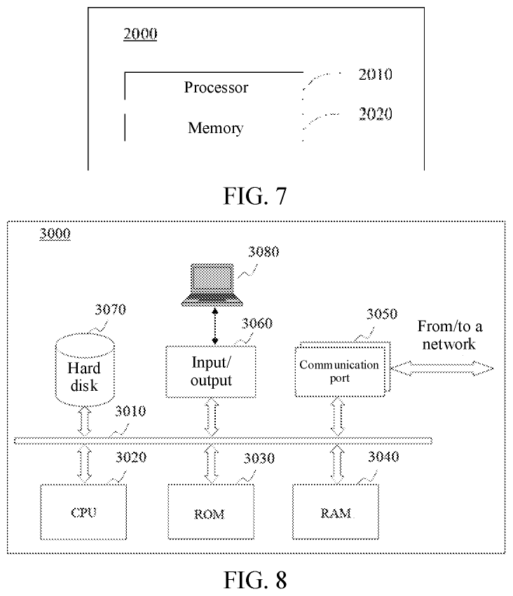

According to another aspect of the present disclosure, an electronic device is further provided, which is configured to implement the method according to the embodiments of the present disclosure. FIG. 7 is a schematic diagram of an electronic device 2000 according to some embodiments of the present disclosure.

As shown in FIG. 8, the electronic device 2000 may include one or more processors 2010 and one or more memories 2020. A memory 2020 stores computer-readable code. The computer-readable code, when run by the one or more processors 2010, may perform the method as described above.

A processor in some embodiments of the present disclosure may be an integrated circuit chip, and has a signal processing capability. The foregoing processor may be a general-purpose processor, a digital signal processor (DSP), an application-specific integrated circuit (ASIC), a field programmable gate array (FPGA) or another programmable logical device, a discrete gate or a transistor logical device, or a discrete hardware component. The processor may implement or perform methods, operations and logic block diagrams disclosed in the embodiments of the present disclosure. The general-purpose processor may be a microprocessor, or the processor may be any processor or the like, such as a processor based on an x86 architecture or an ARM architecture.

Some exemplary embodiments of the present disclosure may be implemented in hardware or a dedicated circuit, software, firmware, logic, or any combination thereof. Some aspects may be implemented in hardware, and other aspects may be implemented in firmware or software that may be executed by a controller, a microprocessor, or another computing device. When aspects of some embodiments of the present disclosure are shown or described as block diagrams, flowcharts, or represented by using some other figures, the blocks, apparatuses, systems, techniques, or methods described herein, as non-restrictive examples, may be implemented in hardware, software, firmware, dedicated circuits or logic, general-purpose hardware or a controller or another computing device, or some combinations thereof.

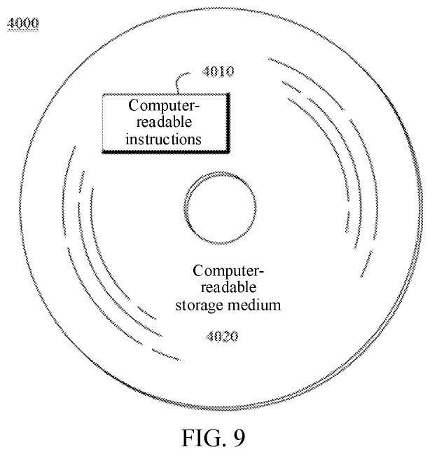

For example, the method or apparatus according to some embodiments of the present disclosure may also be implemented with the help of an architecture of the computing device 3000 shown in FIG. 9. As shown in FIG. 8, the computing device 3000 may include a bus 3010, one or more central processing units (CPUs) 3020, a read-only memory (ROM) 3030, a random-access memory (RAM) 3040, a communication port 3050 connected to a network, an input/output component 3060, a hard disk 3070, and the like. A storage device, for example, the ROM 3030 or the hard disk 3070, in the computing device 3000 may store program instructions executed by a CPU and various data or files configured for processing and/or communication in the method provided in the present disclosure. The computing device 3000 may further include a user interface 3080. Certainly, an architecture shown in FIG. 8 is merely an example. When different devices are implemented, one or more components in the computing device shown in FIG. 8 may be omitted according to actual requirements.

According to still another aspect of the present disclosure, a computer-readable storage medium is further provided. FIG. 9 is a schematic diagram of a storage medium 4000 according to the present disclosure.

As shown in FIG. 9, a computer storage medium 4020 stores computer-readable instructions 4010. The computer-readable instructions 4010, when executed by a processor, may perform the method according to the embodiments of the present disclosure described with reference to the foregoing accompanying drawings. The computer-readable storage medium in some embodiments of the present disclosure may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM), which is used as an external cache. Through illustrative but not limited description, RAMs in many forms are available, for example, a static random-access memory (SRAM), a dynamic random-access memory (DRAM), a synchronous dynamic random-access memory (SDRAM), a double data rate synchronous dynamic random-access memory (DDRSDRAM), an enhanced synchronous dynamic random-access memory (ESDRAM), a synch link dynamic random-access memory (SLDRAM) and a direct rambus random-access memory (DRRAM). The memory in the method described in the present disclosure is intended to include but is not limited to these memories and any other memory of a suitable type. The memory in the method described in present disclosure is intended to include but is not limited to these memories and any other memory of a suitable type.

In addition or alternatively, some embodiments of the present disclosure further provide a storage medium, the storage medium being configured to store a computer program, and the computer program being configured to perform the method provided by the foregoing embodiments.

Some embodiments of the present disclosure further provide a computer program product including a computer program, the computer program product, when run in a computer, causing the computer to perform the method provided by the foregoing embodiments.

According to some embodiments of the present disclosure, a neural network training method is performed by a computer device. The neural network includes an audio-to-expression transformer and an expression-to-face renderer. The method includes determining sample facial prior information of a virtual object based on sample video data; determining a sample target audio feature based on sample audio data corresponding to the sample video data; determining a predicted value of target sample expression sequence information based on the sample facial prior information and the sample target audio feature by using the audio-to-expression transformer; training the audio-to-expression transformer based on the predicted value of the target sample expression sequence information by using a first loss function; determining a sample reference frame and a sample source video frame based on the sample video data; and training the expression-to-face renderer based on the sample facial prior information, the sample reference frame, and the sample source video frame by using a second loss function.

The sample facial prior information includes an actual value of sample target expression sequence information. The determining of a predicted value of sample target expression sequence information by using the audio-to-expression transformer includes masking an actual value of facial prior information of the virtual object to obtain masked facial prior information of the virtual object; and determining a predicted value of the sample target expression sequence information of the virtual object based on the masked facial prior information of the virtual object and a sample audio feature by using the audio-to-expression transformer.

The sample facial prior information includes an actual value of sample target expression sequence information. The training of the expression-to-face renderer includes masking the sample source video frame based on an actual value of a sample target expression sequence, to obtain a masked sample source video frame; determining a predicted value of the sample source video frame for the masked sample source video frame based on the sample facial prior information and the sample reference frame by using the expression-to-face renderer; and training the expression-to-face renderer based on the predicted value and an actual value of the sample source video frame by using the second loss function. The second loss function including one or a combination of more of the following: a pixel loss, a perceptual loss, an adversarial loss, and a local pixel loss.

According to some embodiments of the present disclosure, a neural network training apparatus includes at least one memory configured to store computer program code; and at least one processor configured to read the program code and operate as instructed by the program code. The program code includes first determining code configured to cause the at least one processor to determine sample facial prior information of a virtual object based on sample video data; second determining code configured to cause the at least one processor to determine a sample target audio feature based on sample audio data corresponding to the sample video data; third determining code configured to cause the at least one processor to determine a predicted value of target sample expression sequence information based on the sample facial prior information and the sample target audio feature by using the audio-to-expression transformer; first training code configured to cause the at least one processor to train the audio-to-expression transformer based on the predicted value of the target sample expression sequence information by using a first loss function; fourth determining code configured to cause the at least one processor to determine a sample reference frame and a sample source video frame based on the sample video data; and second training code configured to cause the at least one processor to train the expression-to-face renderer based on the sample facial prior information, the sample reference frame, and the sample source video frame by using a second loss function.

Some embodiments provide technical improvements in computer technology. For example, synchronization precision between audio content and a facial component (for example, a mouth) action of the virtual object can be significantly improved, a sense of reality of a mouth action is enhanced, an expression difference between individuals is captured and reproduced more accurately, and operation efficiency and stability of the whole system are improved while system performance is improved.

The flowcharts and block diagrams in the accompanying drawings illustrate possible system architectures, functions and operations that may be implemented by a system, a method, and a computer program product according to various embodiments of the present disclosure. In this regard, each box in a flowchart or a block diagram may represent a module, a program segment, or a part of code. The module, the program segment, or the part of code includes one or more executable instructions configured for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

Some embodiments of the present disclosure may be implemented in hardware or a dedicated circuit, software, firmware, logic, or any combination thereof. Some aspects may be implemented in hardware, and other aspects may be implemented in firmware or software that may be executed by a controller, a microprocessor, or another computing device. When aspects of some embodiments of the present disclosure are shown or described as block diagrams, flowcharts, or represented by using some other figures, the blocks, apparatuses, systems, techniques, or methods described herein, as non-restrictive examples, may be implemented in hardware, software, firmware, dedicated circuits or logic, general-purpose hardware or a controller or another computing device, or some combinations thereof.

The foregoing detailed exemplary embodiments of the present disclosure are merely illustrative rather than restrictive. A person skilled in the art is to understand that various modifications and combinations of these embodiments or their features may be made without departing from the principles and spirit of the present disclosure, and such modifications are to fall within the scope of the present disclosure.

What is claimed is:

1. An audio data processing method, the method being performed by a computer device and the method comprising:
determining facial prior information of a virtual object based on reference video data;
determining a target audio feature based on target audio data;
determining target expression sequence information based on the facial prior information and the target audio feature; and
determining target video data corresponding to the target audio data based on the target expression sequence information and a reference frame in the reference video data.

2. The audio data processing method according to claim 1, wherein the facial prior information comprises at least one of: reference facial shape information, reference expression information, or reference head pose information.

3. The audio data processing method according to claim 2, wherein the determining of the target expression sequence information based on the facial prior information and the target audio feature comprises, based on the facial prior information comprising the reference facial shape information and the reference expression information:
encoding the reference facial shape information, the reference expression information, and the target audio feature, to obtain a hidden vector; and
decoding the hidden vector to determine the target expression sequence information.

4. The audio data processing method according to claim 2, wherein the determining of the target video data corresponding to the target audio data based on the target expression sequence information and a reference frame in the reference video data comprises:
extracting a source video frame from the reference video data;
masking the source video frame based on a target expression sequence, to obtain a first video frame, one or more of facial components of the virtual object being replaced with black pixel blocks in the first video frame; and
determining, using the facial prior information, the target video data corresponding to the target audio data based on the first video frame and the reference frame.

5. The audio data processing method according to claim 4, wherein the masking of the source video frame based on the target expression sequence, to obtain the first video frame comprises:
determining, based on the target expression sequence and the reference facial shape information, a pixel region corresponding to the one or more of the facial components of the virtual object in the source video frame; and
modifying pixel values in the pixel region to a preset value, to obtain the first video frame.

6. The audio data processing method according to claim 4, wherein the determining of the target video data corresponding to the target audio data based on the first video frame and the reference frame comprises:
encoding, using a shared-weight encoder, the first video frame and the reference frame, to obtain a first encoded feature of the first video frame and a second encoded feature of the reference frame; and
decoding, using a decoder, the first encoded feature and the second encoded feature based on the facial prior information and the target expression sequence, to obtain the target video data corresponding to the target audio data, the target video data comprising a target video frame, and a region of black pixel blocks in the target video frame being replaced with a predicted value of the one or more of the facial components of the virtual object.

7. The audio data processing method according to claim 6, wherein the decoder comprises a plurality of cascaded decoding layers, an input of each decoding layer comprises an output of a previous decoding layer, the facial prior information, and an encoded feature of the reference frame, and
wherein an output of the each decoding layer is a predicted value of the target video frame.

8. An audio data processing apparatus, the apparatus comprising:
at least one memory configured to store computer program code; and
at least one processor configured to read the program code and operate as instructed by the program code, the program code comprising:
first preprocessing code configured to cause the at least one processor to determine facial prior information of a virtual object based on reference video data;
second preprocessing code configured to cause the at least one processor to determine a target audio feature based on target audio data;
audio-to-expression transformer code configured to cause the at least one processor to determine target expression sequence information based on the facial prior information and the target audio feature; and
expression-to-face renderer code configured to cause the at least one processor to determine target video data corresponding to the target audio data based on the target expression sequence information and a reference frame in the reference video data.

9. The audio data processing apparatus according to claim 8, wherein the facial prior information comprises at least one of: reference facial shape information, reference expression information, or reference head pose information.

10. The audio data processing apparatus according to claim 9, wherein the audio-to-expression transformer code is further configured to cause the at least one processor to, based on the facial prior information comprising the reference facial shape information and the reference expression information:
encode the reference facial shape information, the reference expression information, and the target audio feature, to obtain a hidden vector; and
decode the hidden vector to determine the target expression sequence information.

11. The audio data processing apparatus according to claim 9, wherein the expression-to-face renderer code is further configured to cause the at least one processor to:
extract a source video frame from the reference video data;
mask the source video frame based on a target expression sequence, to obtain a first video frame, one or more of facial components of the virtual object being replaced with black pixel blocks in the first video frame; and
determine, using the facial prior information, the target video data corresponding to the target audio data based on the first video frame and the reference frame.

12. The audio data processing apparatus according to claim 11, wherein the expression-to-face renderer code is further configured to cause the at least one processor to:
determine, based on the target expression sequence and the reference facial shape information, a pixel region corresponding to the one or more of the facial components of the virtual object in the source video frame; and
modify pixel values in the pixel region to a preset value, to obtain the first video frame.

13. The audio data processing apparatus according to claim 11, wherein the expression-to-face renderer code is further configured to cause the at least one processor to:
encode, using a shared-weight encoder, the first video frame and the reference frame, to obtain a first encoded feature of the first video frame and a second encoded feature of the reference frame; and
decode, using a decoder, the first encoded feature and the second encoded feature based on the facial prior information and the target expression sequence, to obtain the target video data corresponding to the target audio data, the target video data comprising a target video frame, and a region of black pixel blocks in the target video frame being replaced with a predicted value of the one or more of the facial components of the virtual object.

14. The audio data processing apparatus according to claim 13, wherein the decoder comprises a plurality of cascaded decoding layers, an input of each decoding layer comprises an output of a previous decoding layer, the facial prior information, and an encoded feature of the reference frame, and
wherein an output of the each decoding layer is a predicted value of the target video frame.

15. A non-transitory computer-readable storage medium, storing computer program code, when executed by at least one processor, causes the at least one processor to at least:
determine facial prior information of a virtual object based on reference video data;
determine a target audio feature based on target audio data;
determine target expression sequence information based on the facial prior information and the target audio feature; and
determine target video data corresponding to the target audio data based on the target expression sequence information and a reference frame in the reference video data.

16. The non-transitory computer-readable storage medium according to claim 15, wherein the facial prior information comprises at least one of: reference facial shape information, reference expression information, or reference head pose information.

17. The non-transitory computer-readable storage medium according to claim 16, wherein the computer program code, when executed by the at least one processor, further causes the at least one processor to at least:
based on the facial prior information comprising the reference facial shape information and the reference expression information:
encode the reference facial shape information, the reference expression information, and the target audio feature, to obtain a hidden vector; and
decode the hidden vector to determine the target expression sequence information.

18. The non-transitory computer-readable storage medium according to claim 16, wherein the computer program code, when executed by the at least one processor, further causes the at least one processor to at least:
extract a source video frame from the reference video data;
mask the source video frame based on a target expression sequence, to obtain a first video frame, one or more of facial components of the virtual object being replaced with black pixel blocks in the first video frame; and
determine, using the facial prior information, the target video data corresponding to the target audio data based on the first video frame and the reference frame.

19. The non-transitory computer-readable storage medium according to claim 18, wherein the computer program code, when executed by the at least one processor, further causes the at least one processor to at least:
determine, based on the target expression sequence and the reference facial shape information, a pixel region corresponding to the one or more of the facial components of the virtual object in the source video frame; and
modify pixel values in the pixel region to a preset value, to obtain the first video frame.

20. The non-transitory computer-readable storage medium according to claim 18, wherein the computer program code, when executed by the at least one processor, further causes the at least one processor to at least:
encode, using a shared-weight encoder, the first video frame and the reference frame, to obtain a first encoded feature of the first video frame and a second encoded feature of the reference frame; and
decode, using a decoder, the first encoded feature and the second encoded feature based on the facial prior information and the target expression sequence, to obtain the target video data corresponding to the target audio data, the target video data comprising a target video frame, and a region of black pixel blocks in the target video frame being replaced with a predicted value of the one or more of the facial components of the virtual object.
